(19) United States
(12) Patent Application Publication
(10) Pub. No.: US 2002/0087678 A1
(43) Pub. Date: Jul. 4, 2002

(54) Intelligent management of information in a network environment

(76) Inventor: Gabriel Padilla, Rocklin, CA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 10/032,811

(22) Filed: Oct. 26, 2001

Related U.S. Application Data
(60) Provisional application No. 60/244,070, filed on Oct. 27, 2000.

(51) Int. Cl. G06F 15/173; G06F 17/30; G06F 7/00

(52) U.S. Cl. 709/223; 707/10

(57) ABSTRACT

An information management system handles the organization, distribution, and access of networked information. The system creates a network of linked groups of members, where links established between groups facilitate the network sharing of information maintained on behalf of individual groups. Access rights settings that govern the distribution of networked information are designated for individual members, groups, and/or links between groups. In response to such access rights settings, each piece of information can be managed in an appropriate fashion such that networked information is efficiently distributed to groups and members.

### RELATED APPLICATION

This application is related to, and claims priority of, U.S. provisional application serial No. 60/244,070, the content of which is hereby incorporated by reference.

### FIELD OF THE INVENTION

The present invention relates generally to the processing of networked information. More particularly, the present invention relates to a distributed system for the organization, distribution, management, and handling of information for multiple users.

### BACKGROUND OF THE INVENTION

The increasing popularity of computer-generated information (e.g., word processor documents, spreadsheet files, data files, emails, and the like) has created practical limitations related to the manner in which such information is stored, protected, distributed, organized, and managed. In reality, much of the information is naturally interwoven, interacting with similar or related information. For example, a large company or enterprise may generate hundreds of documents each day. Many of these documents may be intended for widespread distribution to a large number of recipients. On the other hand, some information useful to one group of people may be unsuitable or irrelevant to another group of people. In addition, searching for particularly relevant information may be difficult in a practical environment where a large number of users, groups of users, information sources, and data coexist.

Prior art systems such as the web-based system from eRoom Technology, Inc., PLUMTREE, and LOTUS NOTES are typically based on information organization schemes that utilize centralized management and hierarchical group security. These common techniques facilitate the delivery and presentation of information to individuals assigned to specific groups. However, these and other prior art systems exhibit deficiencies in one or more practical features such as distributed management across many different types of users, data relevance, contextual computing, automatic information management, and optimized linking of information to users. Such prior art systems cannot effectively support the aggregation of data from multiple sources. Indeed, prior art applications often waste system resources by bombarding users with a large amount of irrelevant or unnecessary information and/or by distributing information that is difficult to tailor to the specific needs of the users. In addition, the end users may spend valuable time perusing irrelevant information (such as broadcast emails), storing information, organizing and managing information, sharing data, and/or searching for relevant information. Often, the centralized management creates common administrative and security bottlenecks that are frustrating for all users.

### BRIEF SUMMARY OF THE INVENTION

The present invention provides a system for the intelligent management of information in a network environment. The system is particularly suited for use as a many-to-many or group-to-group management system where there exists a need for multiple work spaces. The system allows any amount of information (such as electronic documents, files, email, address book entries, calendar entries, notes, and spreadsheets) to be associated with any number of individual users in an efficient manner throughout a large network encompassing one or more enterprises, and in varying degrees of relevance. The users can be members of any number of groups and any number of subgroups representing different criteria. In addition, a group can be linked to any number of other groups or subgroups. The system is capable of storing information and distributing information based on the degree of relevance of the information to the individual users, groups, or subgroups.

In one embodiment, the system employs multiple servers that are interconnected to a common network such as the Internet. The system provides a user interface that can be rendered on any number of presentation devices, e.g., a personal computer, a wireless telephone, or a personal digital assistant. Consequently, the information access features of the present invention can be efficiently deployed in an Internet environment having an unlimited number of users associated with an unlimited amount of information.

In a practical implementation, the present invention promotes the efficient and speedy delivery of information, increased end user productivity, and increased self-service by end users. In addition, the techniques of the present invention can address one or more of the following problems associated with conventional information management systems: information overload from the user's perspective; search engine limitations; difficulty in unifying information; no access to targeted information; and lack of privacy and authentication.

### BRIEF DESCRIPTION OF THE DRAWINGS

A more complete understanding of the present invention may be derived by referring to the detailed description and claims when considered in conjunction with the following Figures, wherein like reference numbers refer to similar elements throughout the Figures.

FIG. 1 is a schematic representation of an information management system environment.

FIG. 2 is a schematic diagram of an example information grouping architecture that may be utilized in the context of the present invention.

FIG. 3 is a schematic diagram that depicts the manner in which information can be distributed throughout groups and subgroups in a distributed network environment.

FIG. 4 is a schematic representation of an example server software architecture.

### DETAILED DESCRIPTION OF A PREFERRED EMBODIMENT

The present invention may be described herein in terms of functional block components and various processing steps. It should be appreciated that such functional blocks may be realized by any number of hardware components configured to perform the specified functions. For example, the present invention (or a system that embodies the present invention) may employ various integrated circuit components, e.g., memory elements, digital signal processing elements, logic elements, look-up tables, and the like, which may carry out a variety of functions under the control of one or more microprocessors or other control devices. In addition, those skilled in the art will appreciate that the present invention may be practiced in conjunction with any number of data transmission protocols and that the system described herein is merely one exemplary application for the invention.

It should be appreciated that the particular implementations shown and described herein are illustrative of the invention and its best mode and are not intended to otherwise limit the scope of the invention in any way. Indeed, for the sake of brevity, conventional techniques for data transmission, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical embodiment.

A preferred practical embodiment of the present invention allows a large number of users to organize, store, manage, and distribute information in an efficient and effective manner. Such a practical embodiment may be realized as an information management system (described in detail below). For purposes of the present invention, “information” refers to data that can be electronically formatted in a suitable manner. In this respect, the information may be created, stored, accessed, transmitted, modified, and/or otherwise manipulated in an electronic manner. For example, the information may be realized in the form of word processor documents, graphics files, media files such as audio or video files, executable application files, email files, spreadsheet files, uniform resource locator (URL) bookmarks, address book files, database files, reports, and the like. The present invention may be utilized to manage any type of information or data, and the examples listed above are not intended to limit the scope or application of the invention in any way.

The information management system preferably enables an authorized end user to designate the manner in which certain information can be accessed by and/or distributed to other end users (and/or to groups other than the originating or posting group). For example, a creator of a document can assign Read, Write, and/or Modify rights to any number of individual end users or groups of end users within the security environment defined by the groups associated with the creator and/or the end users. The information management system preferably employs a grouping or relationship structure that facilitates enhanced information management and enhanced information searching capabilities. In this regard, networked information maintained on behalf of one group (e.g., information “owned” by the group, created by members of the group, or initially posted at the group) can be shared with other groups. In addition, the system allows information to be synchronized such that end users are not exposed to multiple inconsistent versions of information, e.g., different versions of a document or data file.

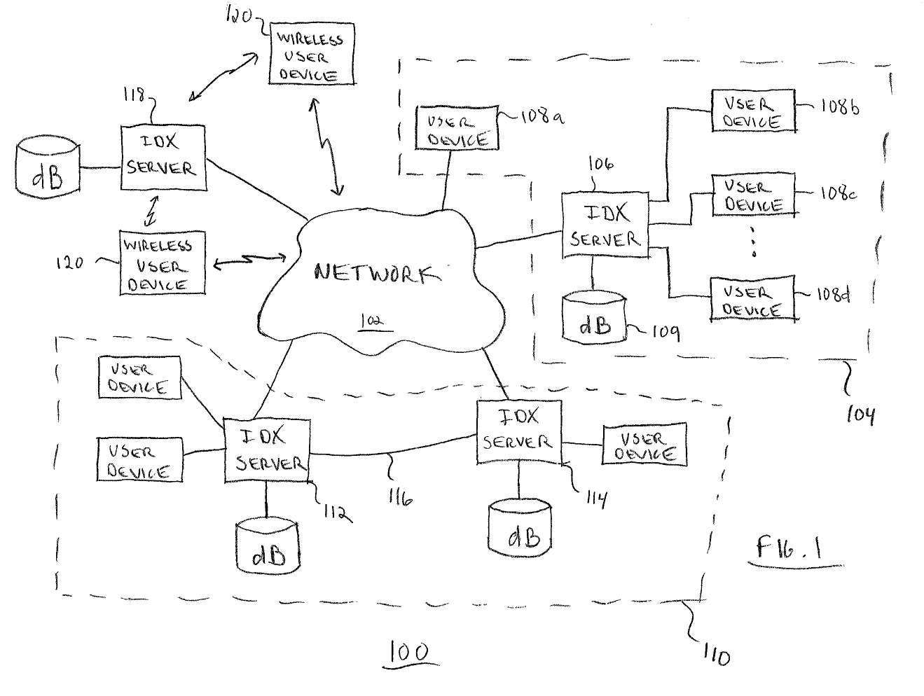

FIG. 1 is a schematic block diagram of an information management system environment 100 configured in accordance with the present invention. Information management system environment 100 utilizes a data communication network 102 to facilitate the transmission, access, organization, and manipulation of information. Network 102 may be a local area network (LAN), a wide area network (WAN), the Internet, or any suitable network capable of supporting the requirements of the information management system. In addition, network 102 may include wireless networking elements, e.g., cellular telecommunication components, wireless personal digital assistant (PDA) gateways, or the like. The operation of network 102 may follow any number of conventional techniques and protocols known to those skilled in the art.

The information management system environment 100 may include any number of individual information management systems, whether discrete or interconnected. For example, FIG. 1 depicts an information management system 104 as a stand-alone system (represented by the dashed lines). The remaining elements shown in FIG. 1 may be associated with one or more other information management systems. Each information management system preferably includes at least one server associated therewith. Although atypical in a practical implementation, a single server may support multiple information management systems. For purposes of an Internet-based example embodiment, the system servers are referred to as Internet Data Exchange (IDX) servers because they can be configured to enable information access and distribution via the Internet. In this regard, an IDX server may be realized in conjunction with a web server. In practice, the IDX servers can be maintained by the respective enterprises or by a third party administrator.

As used herein, a “server” refers to a computing device or system configured to perform any number of functions and operations associated with a given information management system. Alternatively, a “server” may refer to software that performs the processes, methods, and/or techniques described herein. From a hardware perspective, a system may utilize any number of commercially available servers, e.g., the IBM AS/400, the IBM RS/6000, the SUN ENTERPRISE 5500, the COMPAQ PROLIANT ML570, and those available from UNISYS, DELL, HEWLETT-PACKARD, or the like. Such servers may run any suitable operating system such as UNIX, LINUX, WINDOWS, or WINDOWS NT, and may employ any suitable number of microprocessor devices, e.g., the PENTIUM family of processors by INTEL or the processor devices commercially available from ADVANCED MICRO DEVICES, IBM, SUN MICROSYSTEMS, or MOTOROLA.

The server processors communicate with system memory (e.g., a suitable amount of random access memory), and an appropriate amount of storage or “permanent” memory. The permanent memory may include one or more hard disks, floppy disks, CD-ROM, DVD-ROM, magnetic tape, removable media, solid state memory devices, or combinations thereof. In accordance with known techniques, the operating system programs and any server application programs reside in the permanent memory and portions thereof may be loaded into the system memory during operation. In accordance with the practices of persons skilled in the art of computer programming, the present invention is described below with reference to operations that may be performed by one or more servers associated with the information management systems, e.g., the IDX servers. Such operations are sometimes referred to as being computer-executed. It will be appreciated that such operations include the manipulation by the various microprocessor devices of electrical signals representing data bits at memory locations in the system memory, as well as other processing of signals. The memory locations where data bits are maintained are physical locations that have particular electrical, magnetic, optical, or organic properties corresponding to the data bits.

When implemented in software, various elements of the present invention are essentially the code segments that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

In the illustrated embodiment, information management system 104 includes an IDX server 106, which services any number of different user devices 108 and any number of groups. As used herein, a user device is any hardware or software component capable of supporting the end user features of the present invention. For example, a user device may be realized as a desktop or laptop personal computer (PC), a wireless telephone device, a PDA, an Internet-compliant television or home entertainment system, an email device, or the like. A number of user devices may be interconnected together via a LAN, a WAN, or other network arrangement. In a practical implementation, each user device includes a display element, a user interface, a suitably powerful processor, and a suitable amount of memory. The user devices enable the end users to interact with a graphical user display generated by the respective information management systems.

Information management system 104 includes a number of user devices 108b, 108c, 108d coupled to IDX server 106. In addition, system 104 can support a user device 108a via network 102. For example, user device 108a maybe a portable computer that directly connects to IDX server 106 when the user is at his ordinary workplace, and connects to IDX server 106 remotely via the network 102 when the user is working at home. Information management system 104 is flexibly configured to support different user devices that can access EDX server 106 using different techniques and different paths.

IDX server 106 also communicates with at least one database 109, which can be configured in accordance with known database technologies. Database 109 is configured to store the user information (such as documents and files), user identification data, user group designations, security parameters, group linking and relationships, IDX server data, and other data utilized by information management system environment 100.

A second information management system 110 depicts an alternate arrangement having multiple IDX servers 112, 114. IDX servers 112, 114 may be interconnected via network 102 and/or via a suitable communication link 116. The multiple IDX servers 112, 114 may be physically located in one facility or distributed in different locations. A given IDX server 112, 114 may be configured to communicate with a subset of user devices within system 110, or it may be configured to communicate with any user device supported by system 110.

Yet another IDX server 118 may be configured to operate in conjunction with a number of wireless user devices 120. Wireless user devices 120 may communicate with IDX server 118 over a direct wireless link or via network 102 using wireless and other data communication techniques. Of course, IDX server 118 may be further configured to support wired user devices in addition to wireless user devices 120.

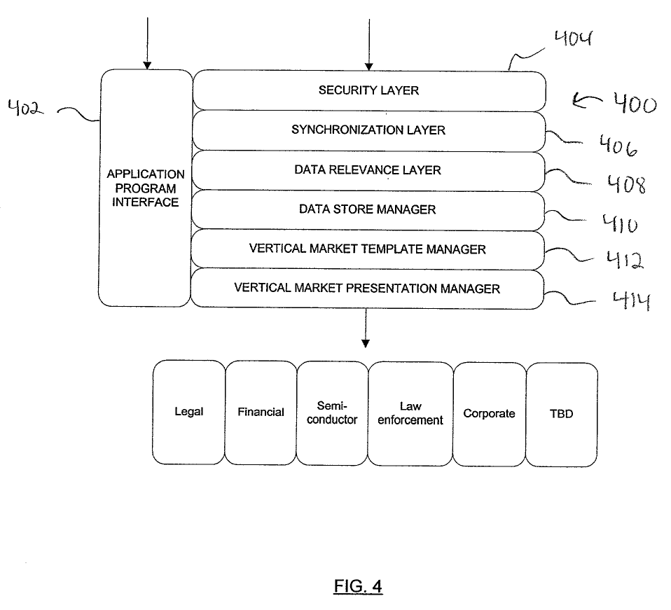

FIG. 4 is a schematic representation of an example software architecture 400 that can be utilized by an IDX server. In a practical networked implementation, IDX servers are configured to communicate with each other and each IDX server utilizes software architecture 400. Architecture 400 includes six layers: a security layer 404, a synchronization layer 406, a data relevance layer 408, a data store manager layer 410, a vertical market template manager layer 412, and a vertical market presentation manager layer 414. As described herein, any number of information sources (associated with individual users, groups, subgroups, etc.) can generate information that is routed to architecture 400 via the communication network.

In operation, the respective IDX server receives information and feeds it into the layered architecture 400 via an application program interface (API) 402 or via a direct interface. The information passes through the first four layers, where it is handled, processed, and otherwise prepared for delivery. Security layer 404 processes the information in response to access rights designations, group and subgroup membership, linking between groups and subgroups within the system, and other settings and parameters that impact the manner in which the information is distributed throughout the network. Synchronization layer 406 maintains information balance across the network. For example, content on a web page or in a file folder of a workgroup that is synchronized from an original source on the network is dynamically updated across the network when the source document is modified. Synchronization layer 406 facilitates such updating.

Data relevance layer 408 acts as a filter to place highly relevant information in the forefront while providing “drill down” access to less relevant information. The concept of relevance and the manner in which the system determines or designates relevance is described in more detail below. Data store manager layer 410 communicates with data relevance layer 408 and with synchronization layer 406 to manage the database or databases associated with the respective IDX server. Data store manager layer 410 may also be responsible for the management of application sources or manual input of information feeding the networked groups, subgroups, and presentation web pages.

The first four layers of software architecture 400 need not be specific to any particular “real world” application or environment. Thus, the bulk of the IDX server processing need not be customized to suit the particular implementation; such customization can be left to the last two layers. Vertical market template manger layer 412 defines the generic information delivery layout required by the particular industry segment or the specific system administrator's business requirements. This enables one to template the primary use of the software architecture 400 to accommodate a wide spectrum of business requirements. Vertical market presentation manager layer 414 adds further granular customization or branding by industry, company division, brand name, or the like. This layer allows each unique user group (e.g., each enterprise deployment of one or more IDX servers) to develop its own branded identity or appearance. In a practical embodiment, this layer is related to the ultimate display and organization of information at the end user presentation devices.

FIG. 4 illustrates several practical deployments of a networked information management system. Example deployments include: use in connection with a legal referral network; use in connection with the distribution of financial market data; use in connection with the distribution of semiconductor test data; use in connection with the sharing of resources between law enforcement entities; use in a general corporate setting. Of course, software architecture 400 can be customized to support any specific application and these examples are not intended to limit the scope of the invention in any way.

An information management system according to the present invention utilizes a network of interlinked groups in a manner that facilitates efficient information distribution, access, and searching. In the context of the present invention, a group is a collection of persons, resources, organizations, entities, enterprises, or the like. In a practical implementation, an individual person may be a member of any number of different groups within a given system. A group can also include a collection of other groups. Furthermore, a group can be a subgroup of another group or, conversely, a parent group for any number of subgroups. In one practical embodiment, any number of “project” folders can be associated with one or more groups. For example, a project folder titled “System Development” may be created within a group titled “Design Team.” The System Development folder may store information relevant to that particular project such that members of the Design Team group can easily access such information. In addition, the system may be configured such that members of other groups (e.g., members of a group titled “Management”) may also directly or indirectly access this information.

A group can serve as a creator or originator of networked information and/or as a collector of networked information. When a group is functioning as an originator, information posted by members of the group is stored and maintained by the respective IDX server on behalf of the group. When a group is functioning as a collector, it accesses, retrieves, and/or receives information maintained by an IDX server for one or many groups. Assuming that the collector group has proper information access rights to the networked information, it can store, format, and otherwise process the collected information for use by its members.

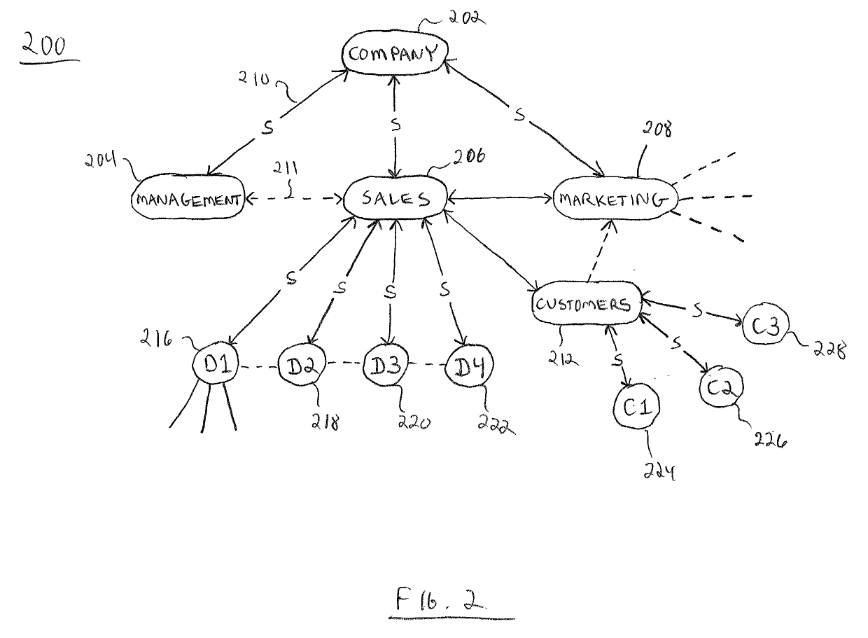

FIG. 2 is a schematic diagram of an example information grouping architecture 200 that may be utilized in the context of the present invention. This specific grouping architecture is not intended to limit the scope or applicability of the present invention. Rather, grouping architecture 200 is presented here for illustrative purposes. In the preferred embodiment, a grouping architecture is established within an information management system by the individual end users or group members. In this respect, the information management system need not rely on centralized regulation of the information grouping, centralized administration of access rights, or centralized security features. Rather, as each group or subgroup is created, an administrator of that group is allowed to designate the immediate members of the group, request access rights to other groups (for access or sharing of resources maintained on behalf of those groups), provide sharing rights to other groups, designate user privileges for the group, and/or set other options and preferences associated with the group. The group administrator of a new group can request an access link to an existing group via, e.g., an email message to the administrator of the existing group. If the administrator of the existing group grants permission, a suitable link can be established between the two groups; the respective IDX server or servers can be updated in a suitable manner to reflect the new link or links.

Notably, all members in a given group need not be supported by the same IDX server, and all members in a given group need not be associated with a single enterprise or entity. Indeed, a group or subgroup may include members supported by different IDX servers throughout the network. Consequently, a grouping architecture such as architecture 200 may represent groups and subgroups of members corresponding to any number of distributed IDX servers. Eventually, the information management system structure is established through the creation of different groups, the relationships between individuals, groups, and subgroups, and the different access and security features associated with the different groups and subgroups.

In a practical deployment, an initial or default grouping architecture may be provided as a starting point. An initial grouping architecture can have any number of defined groups, subgroups, links between groups and/or subgroups, and designated access rights that are pertinent to the particular application for which the system is designed. Over time, the initial grouping architecture may be modified to reflect new or modified groups and subgroups, changed access rights, additional members, and the like. Alternatively, the information management system can be initially deployed as a “blank slate” with no established groups or links between groups; the members, system administrators, and/or group administrators are responsible for the creation of the grouping architecture. In either embodiment, the grouping architecture can be created or modified in a decentralized manner by members or group administrators associated with any number of distributed IDX servers.

The example information grouping architecture 200 assumes that the information management system is deployed in connection with a particular company having a number of organizational departments (e.g., accounting, sales, advertising, management, marketing, etc.), a number of employees, and a number of customers. Information grouping architecture 200 includes a Company group 202, which may be considered to be at the highest group “level” in this example. In a practical embodiment, every employee of the company may be included in the Company group 202. Consequently, information contained in the Company group 202 can be accessed by a large number of authorized end users.

Information grouping architecture 200 may also include any number of groups (or subgroups) associated with the Company group 202. As used herein, a subgroup may be a subset of a parent group in that access to a parent group provides potential access to a corresponding subgroup. In this respect, each member of a subgroup can also be a member of the related parent group, albeit in an implicit manner in some cases. In the example shown in FIG. 2, a Management group 204, a Sales group 206, and a Marketing group 208 are all subgroups of the Company group 202 (FIG. 2 identifies subgroups by the letter “S” in the intergroup links).

In the example information grouping architecture, Management group 204, Sales group 206, and Marketing group 208 are each linked to the Company group 202 via two-way links (represented by double-headed arrows in FIG. 2). As used herein, a two-way link is a link that provides bi-directional access to authorized information between the linked groups. In contrast, a one-way link (represented by single-headed arrows in FIG. 2) only provides unidirectional access to information between two linked groups, where the group with access rights is the linking group and the group providing information is the linked group. Thus, the two-way link 210 between the Company group 202 and the Management group 204 allows members of the Company group 202 to access information administered by the Management group 204, subject to Read/Write and other security measures (in the context of the present invention, any given group may be associated with the administration, creation, storage, maintenance, and/or management of information). Similarly, the two-way link 210 allows members of the Management group 204 to access information administered by the Company group 202. In a practical embodiment, the link between a parent group and its child group will typically be a two-way link.

An information grouping architecture may utilize explicit/direct links and implicit/indirect links between groups and subgroups. For purposes of this description, an explicit link refers to direct access to information by explicit members of a group. For example, explicit links are formed between a parent group and a subgroup. Explicit links may also be created (by group administrators) between any two groups or subgroups that may otherwise be unrelated in a traditional hierarchical sense. FIG. 2 depicts explicit links as solid lines between the groups. In a practical embodiment, explicit links connected to a group are usually, but need not be, visible or readily accessible to the members of that group. In other words, the graphical display interface rendered on a group member's user device may display a listing of explicitly linked groups to allow easy access to (or retrieval of) directly linked information.

An implicit link refers to indirect access to information via one or more “intervening” groups. For example, implicit access occurs when a first group accesses a second group by way of a third group. This may occur when the first and second groups are sibling subgroups of a common parent group or when a subgroup of a parent group relies on the parent group's links. In FIG. 2, a Customers group 212 is implicitly linked to the Marketing group 208 via the Sales group 206 (FIG. 2 depicts implicit links as dashed lines between the groups). In other words, members of the Customers group 212 have explicit access to at least some of the information maintained by the Sales group 206, and members of the Sales group 206 have explicit access to at least some of the information maintained by the Marketing group 208. Thus, members of the Marketing group 208 may have access to information administered by the Customers group 212, subject to any security measures that may be in place between the various groups. In a practical implementation, sibling subgroups (such as the Management group 204, the Sales group 206, and the Marketing group 208) are inherently connected to each other via implicit links because they share a common parent group (e.g., the Company group 202). For example, a two-way implicit link 211 is established between the Management group 204 and the Sales group 206 because members of each group may access some of the information associated with the other group via membership in the Company group 202.

In the preferred embodiment, implicit links may not be prominently displayed on the group member's display device. This feature reduces the amount of low priority or irrelevant information presented to the end user. Thus, although such information may be available, the end user can only access it in an indirect manner. In a practical embodiment, an end user may have the option to make implicit links visible on demand.

With continued reference to FIG. 2, a subgroup may include any number of sub-subgroups arranged in a hierarchical or “family tree” architecture. For example, the Sales group 206 may be a parent group to a number of Sales Director groups 216, 218, 220, 222. In turn, any of the Sales Director groups may serve as a parent group to any number of subgroups related to, e.g., sales staff, sales managers, or the like. A parent group may have any number of sibling subgroups, such as the Sales Director groups 216, 218, 220, 222, along with any number of unrelated groups, such as the Customers group 212 (which, in this example, is not a subgroup of the Sales group 206). In this example, the Customers group 212 need not be treated like a sibling of any of the Sales Director groups. Consequently, no inherent implicit link is established between the Customers group 212 and any of the Sales Director groups. As shown in FIG. 2, the Customers group 212 serves as a parent group to a number of Specific Customer groups 224, 226, 228. Thus, members of the Sales group 206 can access information administered by the Specific Customer groups 224, 226, 228 via the Customers group 212 (subject to various security measures established by the various group administrators and/or the creators of the posted information).

To summarize, a practical architecture can include any number of groups and subgroups that may be interrelated using different links. A single group may be linked to any number of other groups (sibling groups, ancestor groups, or descendant groups) depending upon the system preferences. When a first group is linked to a second group, the members of the first group gain access to resources maintained by the second group, e.g., files and member directory information. A link can be implicit or explicit and one-way or two-way. Each link represents the type and amount of a resource that can be accessed by the linked group. In addition, the link also specifies the degree of visibility associated with the linked information, such as whether the linked information will appear on the group's home page. The group linking structure, the characteristics of the links, and the access rights corresponding to the different groups and the different links are maintained and managed by the IDX servers.

An information management system according to the present invention also utilizes a security model that allows information to be protected by the end users interacting at the group level. This security model differs from traditional prior art models that require centralized security measures or those that do not address varying degrees of relevance. As an example, if the Marketing group decides to give anyone in the Company group 202 full access to certain information, then all of the subgroups that descend from the Company group 202 can have the same access rights (unless otherwise modified by the subgroups). The links create a security “shell” and individual folders or projects are preferably created such that they have further security attributes. Thus, an individual user may be linked to some information for which he has no authorized access. In the preferred embodiment, an individual end user in any group can define the access rights and security features for his or her information. Thus, the individual end user can designate which linked groups can have access to the information, the extent of the access rights, the levels of exposure of the information, the number of subgroups that the information can be passed through, and other information management parameters. This allows data to be partitioned without the complexities of designating individual user rights. In addition, establishing a link when posting information increases the relevance of that information for certain designated groups.

In conjunction with the creation of the network of groups, information access rights are also designated by the management system. These information access rights are generally associated with the network of groups and, more particularly, the information access rights are associated with the links, the groups, and the individual members. For example, only certain links to an originating group may be given access to networked information maintained on behalf of the originating group, only specified groups and/or subgroups may be given access rights to certain information, and the distribution of some information may be limited to particular end users. In this regard, the provision of member access to networked information can be made dependent on specific group access rights, link access rights, roles or classes of members (e.g., Company Officer, Salaried Employees, Part Time Employees, etc.), and/or individual member access rights; such access rights may be established at the time of group creation and/or at the time that information is posted to a group.

In a practical embodiment, in order to determine what information of the current group to display to the user, the system determines whether the user is a member, a linked visitor, or a visitor. A member is a user who has explicit access to the group. A linked visitor is a member of a linked group but is not a member of the current group. A visitor is a user who is not a member of the current group or any of its linked groups. If the user is a member, the system will show information posted by the group's members as well as information from linked groups of which the user is a member. If the user is a linked visitor, he will only be shown information from linked groups of which he is a member. A visitor will have access to even less information. In many cases, visitors may not have any access to the group.

Once a link has been approved, the linked group may have control over the forwarding and processing of information requests. For example, if a first group requests information via a linked group, the linked group may forward the request to the group responsible for managing that information. Alternatively, the linked group may refuse to forward the request for any number of reasons. Thus, having a mere path to linked information need not imply unlimited access to that information.

The decentralized manner in which access rights and security features are implemented allows information management system environment 100 to be scalable. In this respect, a system according to the present invention can expand the number of groups and subgroups without having to completely overhaul the existing access and security structure. Rather, the creator or administrator of a new group merely defines the linking architecture, access rights, security features, and other information management features associated with the new group. Once the new group is created, the system interacts with the new group resources and regulates access to information in the manner described above. In addition, the security model allows security from several groups to be rolled up into one group or refined by subgrouping. In this respect, the security features can be scaled in a manner that leverages the networking of information.

After a suitable information grouping architecture is established for a given information management system, information can be efficiently distributed, accessed, routed, and managed by considering the relevance and context of the information with respect to the different end users. The degree of relevance for networked information may be based at least in part on a group linking structure of the network. For example, first order links for an end user may be associated with information having the highest priority or the highest degree of relevance to that user. Information that originates from more remotely linked groups would be considered less relevant. In addition, the information itself can be posted by the creator according to its degree of relevance to certain groups or group members. In a practical embodiment, a single piece of information can be associated with multiple groups and the degree of relevance may differ from group to group. The degree of relevance of the information may dictate the manner in which the information is distributed, accessed, displayed, presented to the end user, or otherwise managed by the system. For example, highly relevant information may be obviously displayed on the end user's home page rendered on the user device, while less relevant information may be delegated to embedded folders or hyperlinked pages displayed “below” the user's home page. Thus, an end user can easily access highly relevant information without having to travel through unstructured folders, groups, or web pages to locate the information. Furthermore, an end user need not be required to manually request information because he has no access. In accordance with one preferred aspect of the present invention, the relevance of a given piece of information can be manually altered by an end user to thereby increase its relevance or to downgrade its priority.

The degree of relevance of a piece of information may also vary in response to the data flow path that it follows. For example, certain information associated with the Sales group 206 (such as customer lists or sales volume) may have a relatively high degree of relevance when accessed by or presented to the Marketing group 208. In contrast, the same information may be comparatively less relevant when accessed by or presented to the Management group 204 or the Customers group 212. Furthermore, the information management system can initially designate degrees of relevance for data flow paths without regard to the content or type of information. For example, the system may utilize a default setting that labels information flowing from the Sales group 206 to the Marketing group 208 as “highly relevant” or “high priority” and a default setting that labels information flowing from the Customers group 212 to the Marketing group 208 (via the implicit link) as “slightly relevant” or “low priority.”

Using the techniques of the present invention, the information management system creates context for the information in response to various routing criteria, such as: the path that the information follows from its source to the end user; the identification of the end user; security settings and access rights; and/or how the information interacts with other end users. In accordance with one practical embodiment, the context for a given piece of information is established manually when the information is initially posted to the system. For example, the end user may enter any number of information management parameters related to the piece of information, such as group access rights, specific end user rights, priority, security levels, expiration dates, start dates, and related projects. In an alternate embodiment, the contextual data is entered in an automated manner using neural agents and/or artificial intelligence techniques. In this manner, the information management system can utilize artificial intelligence to determine the relevance of the information and to control the manner in which information is routed to (or accessed by) the end users.

An information management system according to the present invention can utilize the information grouping architecture, information contexts, and user relevance to improve the manner in which end user notifications are distributed. For example, many prior art systems are capable of transmitting global email messages or event notifications to members of a defined distribution list. However, distribution lists do not consider the relevance of the information to the individual end users. Furthermore, end users must manually manage much of the information and manually establish relationships between pieces of information. In contrast, the preferred embodiment of the present invention can leverage the information grouping architecture, links, access rights, and security features such that event notifications (e.g., email distributions, meeting invitations, appointments, or the like) are distributed in an intelligent manner. In other words, the information management system strategically notifies certain end users, based on context and relevance, to reduce the distribution of irrelevant information. In a practical environment, such intelligent notification reduces the amount of distractions experienced by the end users and saves network and system resources (e.g., computational resources, processing time, bandwidth, etc.).

An information management system according to the present invention may also leverage the information grouping architecture, information contexts, dynamic security features, and user relevance to provide enhanced search engine capabilities. For example, in response to an end user's search query, the system is preferably configured to provide search results according to the degree of relevance to the requesting end user. Information searching can be performed with enhanced security and efficiency because the end user can search for groups or information based on his relationships with other groups and other information. Consequently, the sources of the requested information (including group identities, the actual information, the information creators, and the like) can be effectively searched even though the sources are not publicly accessible. In a practical embodiment, the search results can be formatted and sorted in any suitable manner that highlights the degree of relevance to the requesting end user. For example, the search engine may first display information that the end user has already interacted with, followed by information associated with the end user's primary groups, followed by explicitly linked information, followed by implicitly linked information, and so on.

As described above, a stand-alone information management system having any number of interconnected IDX servers may be deployed by a single enterprise. In an alternate embodiment (see FIG. 1), the IDX servers associated with different enterprises can be interconnected to facilitate the exchange of information there between. In a practical information management system environment 100, the IDX servers are suitably configured to communicate with each other via the Internet using conventional data communication techniques and protocols such as the TCP/IP suite of protocols, Simple Object Access Protocol (SOAP), domain name system (DNS) methodologies, and the like. In such an implementation, an information management system according to the present invention can be suitably configured to function like an Internet operating system.

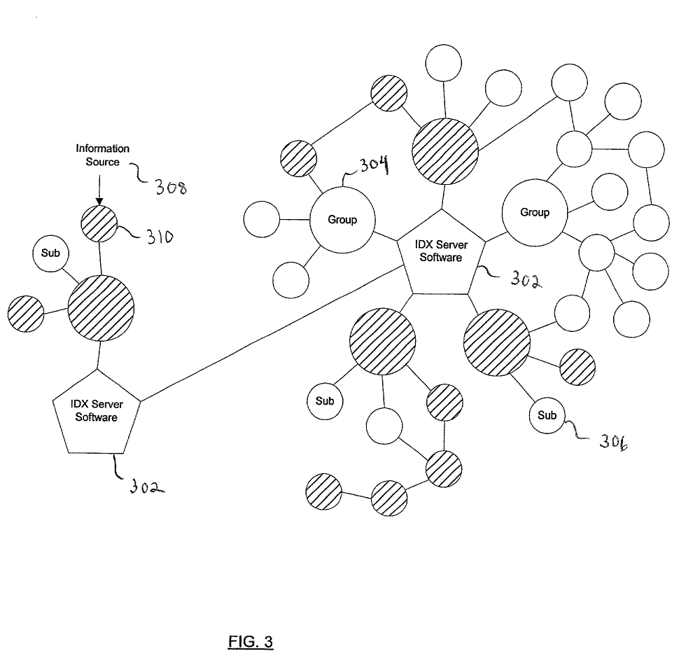

FIG. 3 is a schematic diagram that depicts the manner in which information can be distributed throughout groups and subgroups in a distributed network environment. FIG. 3 is merely intended to illustrate how certain groups and subgroups may have access to a piece of information. As described above, a number of IDX server software architectures 302 are suitably configured to manage and distribute information to any number of groups 304 and to any number of subgroups 306. In FIG. 3, groups are represented by the large circles and subgroups are represented by the small circles. The lines between groups and/or subgroups represent links that facilitate the sharing of information. Shaded circles represent groups and subgroups having access rights to the information, while unshaded circles represent groups and subgroups that are not privy to the information.

A piece of information originates at an information source 308 and is typically made available to the members of an immediate group or subgroup 310. In response to the established network of linked groups and subgroups, the information is also made available to members of those groups and subgroups (subject to any individually designated access limitations). As depicted by the communication link between the two IDX servers, the information can flow between IDX servers such that members corresponding to different enterprises can also access the information. Since the information management system tracks the path of the information flow, the piece of information can be reformatted (using, e.g., XSLT) depending on who is consuming the information. Additionally (or alternatively), the information can be aggregated with other pieces of information.

When deployed in conjunction with a plurality of servers, the information management system becomes a distributed network capable of operating without any centralized regulation or registration requirements. However, such a networked embodiment remains capable of distributing information with security sufficient for most general corporate uses (any number of enhanced security techniques known to those skilled in the art may also be implemented). A networked embodiment can also be configured to support any number of disparate information sources with which an end user communicates. In a practical application, an end user can enjoy an integrated display of different types of information on a centralized home page or other representation. For example, an end user can utilize a single user device (such as a PDA or a laptop computer) to view personal information maintained by one IDX server, work-related information maintained by a second IDX server, school-related information maintained by a third IDX server, and so on.

As described above, each IDX server preferably has at least one database coupled thereto. Information stored on a given database can be copied and distributed to any number of interconnected IDX servers to enable remote end users to access the information. Depending upon the specific security settings, a given piece of information may be restricted such that only one original copy exists on a single server; access to that original copy is regulated by the respective server. In contrast, the system can allow multiple copies of a piece of information to exist on any number of different IDX servers. In addition, a piece of information can be initially posted in conjunction with any number of access and distribution restrictions, e.g., copy limits, propagation limits, Read/Write restrictions, and the like.

The information management system environment 100 is preferably configured to provide information synchronization in response to modifications of data. For example, if an end user accesses and edits a document, the systems can automatically update the document upon reposting. The new version of the document preferably propagates throughout the various interconnected IDX servers to ensure that older versions are superceded. Related linked documents or web content derived from the new document can be updated as well. As another example, if an end user profile or group membership characteristics are updated, the modified information can be distributed throughout the system environment 100 such that the current status of the information grouping architecture remains consistent among the various IDX servers.

In summary, as information management needs continue to grow, the deficiencies of a centralized management solution becomes more apparent, particularly in view of the interwoven and interrelated nature of enterprise data. In large systems, the need to homogenize requirements across many users largely ignores the need to manage information at relatively low workgroup levels. An architecture that allows an extensible network of groups that can interact between themselves provides both a centralizing function (since a group can collect information across many groups) and the need to distribute the management of the information to the users who are creating and interacting with the information.

The present invention has been described above with reference to preferred embodiments. However, those skilled in the art having read this disclosure will recognize that changes and modifications may be made to the preferred embodiments without departing from the scope of the present invention. These and other changes or modifications are intended to be included within the scope of the present invention, as expressed in the following claims.

What is claimed is:

1. A method for the distributed management of networked information, said method comprising:
creating a plurality of groups, each corresponding to a number of members;
establishing links between a number of said plurality of groups to create a network of groups;
designating information access rights associated with said network of groups; and
providing member access to networked information in accordance with said information access rights.

2. A method according to claim 1, farther comprising creating at least one subgroup associated with at least one of said plurality of groups.

3. A method according to claim 1, further comprising posting a piece of information for member access, wherein said designating step designates information access rights corresponding to specific members.

4. A method according to claim 1, further comprising posting a piece of information for member access, wherein said designating step designates information access rights corresponding to at least one of said plurality of groups.

5. A method according to claim 1, further comprising posting a piece of information for member access, wherein said designating step designates information access rights corresponding to specific member roles.

6. A method according to claim 1, wherein said creating step is performed in a decentralized manner by a plurality of end users.

7. A method according to claim 1, wherein said creating step further comprises identifying specific members in at least one of said plurality of groups.

8. A method according to claim 1, further comprising requesting, for a first one of said plurality of groups, access rights to resources maintained on behalf of a second one of said plurality of groups.

9. A method according to claim 1, wherein said establishing step establishes two-way links between at least two of said plurality of groups.

10. A method according to claim 1, wherein said establishing step establishes one-way links between at least two of said plurality of groups.

11. A method according to claim 1, further comprising limiting the number of groups through which networked information can be indirectly accessed by a member.

12. A method according to claim 1, wherein at least one of said plurality of groups functions as a collector of networked information maintained on behalf of at least one other group.

13. A method according to claim 12, wherein said at least one of said plurality of groups functions as an originator of networked information.

14. A method according to claim 1, wherein said information access rights are associated with said links, said plurality of groups, and said members.

15. A method according to claim 1, wherein said providing step provides member access to networked information in accordance with group access rights for said plurality of groups and in accordance with link access rights for said links.

16. A method for the distributed management of networked information, said method comprising:
establishing a network of linked groups, each group corresponding to a number of members;
designating information access rights for information maintained on behalf of at least one group in said network of linked groups; and
managing distribution of said information to at least some members of at least one group in said network in accordance with said information access rights.

17. A method for the distributed management of networked information, said method comprising:
establishing a network of linked groups, each group corresponding to a number of members;
determining a degree of relevance for networked information based at least in part on a group linking structure of said network; and
managing distribution of said networked information based on said degree of relevance.

18. A method according to claim 17, wherein said determining step determines said degree of relevance based at least in part on end user settings.

19. A method according to claim 17, f further comprising managing access to said networked information based on said degree of relevance.

20. A method according to claim 17, further comprising delivering said networked information to member presentation devices in a manner commensurate with said degree of relevance.

21. A method according to claim 17, wherein said determining step determines said degree of relevance based at least in part on the number of linked groups between a first group that maintains said networked information and a second group.

22. A method according to claim 17, wherein said determining step determines said degree of relevance based at least in part on a data flow path between a first group that maintains said networked information and a second group.

23. A method according to claim 17, further comprising creating context for said networked information in response to routing criteria.

24. A method according to claim 23, wherein said routing criteria comprises at least one of:
a data flow path between a first group that maintains said networked information and a second group;
the identification of a recipient of said networked information;
security settings associated with said networked information;
access rights associated with said networked information; and
interaction of said networked information with members of said linked groups.

25. A method according to claim 23, wherein said creating step is performed using a number of neural agents.

26. A method according to claim 23, wherein said creating step is performed using a number of artificial intelligence techniques.
